(19) United States
(12) Patent Application Publication
(10) Pub. No.: US 2003/0087547 A1
(43) Pub. Date: May 8, 2003

(54) Fiberglass sleeved electrical cable assembly

(76) Inventors: Bradley W. Plattner, Kendallville, IN (US); Shawn J. Kondas, Kendallville, IN (US)

Correspondence Address: Todd T. Taylor, TAYLOR & AUST, P.C., 142 S. Main St., P.O. Box 560, Avilla, IN, 46710, US

(21) Appl. No.: 10/010,892

(22) Filed: Nov. 5, 2001

(51) Int. Cl. H01R 13/58

(52) U.S. Cl. 439/465

(57) ABSTRACT

A fiberglass sleeved electrical cable assembly is provided, including a plurality of electrical conductors, a fiberglass sleeve carrying the plurality of electrical conductors therein and a connector, with a housing including a first end having an opening with an inner surface to accommodate the fiberglass sleeve and the plurality of electrical conductors, the inner surface having a plurality of pointed projections, each pointed projection having a ramped side extending farther from the inner surface in a direction away from the opening.

### BACKGROUND OF THE INVENTION

1. Field of the Invention

The present invention relates to an electrical cable assembly, and, more particularly, to a fiberglass sleeved electrical cable assembly.

2. Description of the Related Art

Electrical cable assemblies are used in a plethora of products and throughout industry to provide electrical interconnection. Electrical cable assemblies typically have at least two connectors to provide removable connections. Conductors which extend from one connector to another are normally constrained in close proximity with other conductors. The constraint of conductors is sometimes accomplished by using a sleeve which not only provides for the routing of the conductors but also provides a shield from mechanical abrasion of the conductors with some other object. The sleeve surrounding the conductors is usually secured at each end by the connector housings, to provide continuous protection to the conductors.

An electrical cable assembly with a woven fiberglass sleeve typically has a connector which not only terminates the ends of electrical conductors, carried in the fiberglass sleeve, with interconnecting terminals, but also secures the fiberglass sleeve. Such connectors are typically of two piece construction configured to mate together and each piece has angled chisel-like projections to secure the fiberglass sleeve. The angled chisel-like projections have an edge oriented perpendicular with the direction in which the electrical conductors are directed within the connector. The problem with this sort of assembly is that the angled chisel-like projections cause the fiberglass sleeve to fray and disengage from the connector. The disengaged fiberglass sleeve then fails to properly protect the underlying electrical conductors from abrasion. Another problem with this sort of assembly is that the angled chisel-like projections, particularly after the fiberglass sleeve has disengaged from the connector, may pierce the insulation on the electrical conductors potentially causing short circuits.

One solution to the above problem is to put a protective coating on the ends of each fiberglass sleeve. A coating such as a polymeric material is used to prevent fraying of the fiberglass sleeve. The polymeric material also reduces penetration of the angled chisel-like projections through the fiberglass sleeve. A problem with this solution is that the polymeric material adds material and labor cost to the assembly. Another problem is that the polymeric coating, by reducing the penetration of the angled chisel-like projections, cause extra pressure on the connector assembly which may result in a bowed connector housing.

What is needed in the art is a connector for a woven fiberglass electrical cable assembly which does not cause fraying of the woven fiberglass cable, thereby obviating the need for a protective coating.

### SUMMARY OF THE INVENTION

The present invention provides a fiberglass sleeved cable assembly having a housing with pointed projections which grip and hold a fiberglass sleeve.

The invention comprises, in one form thereof, a fiberglass sleeved electrical cable assembly, including a plurality of electrical conductors, a fiberglass sleeve carrying the plurality of electrical conductors therein and a connector, with a housing including a first end having an opening with an inner surface to accommodate the fiberglass sleeve and the plurality of electrical conductors, the inner surface having a plurality of pointed projections, each pointed projection having a ramped side extending farther from the inner surface in a direction away from the opening.

An advantage of the present invention is that fraying of the fiberglass sleeve is eliminated.

Another advantage is that no polymeric coating of the fiberglass sleeve is required, thereby reducing material and labor costs.

Yet another advantage is that insulation of electrical conductors in the connector is not pierced.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a fiberglass sleeved electrical cable assembly of the present invention;

FIG. 2 is a partially sectioned view of the fiberglass sleeved electrical cable assembly of FIG. 1;

FIG. 3 is a perspective view of a housing portion of the fiberglass sleeved electrical cable assembly of FIGS. 1 and 2;

FIG. 4 is a perspective view of another housing portion of the fiberglass sleeved electrical cable assembly of FIGS. 1 and 2; and

FIGS. 5A, 5B, 5C and 5D depict embodiments of projections of the present invention of FIGS. 1 through 4.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

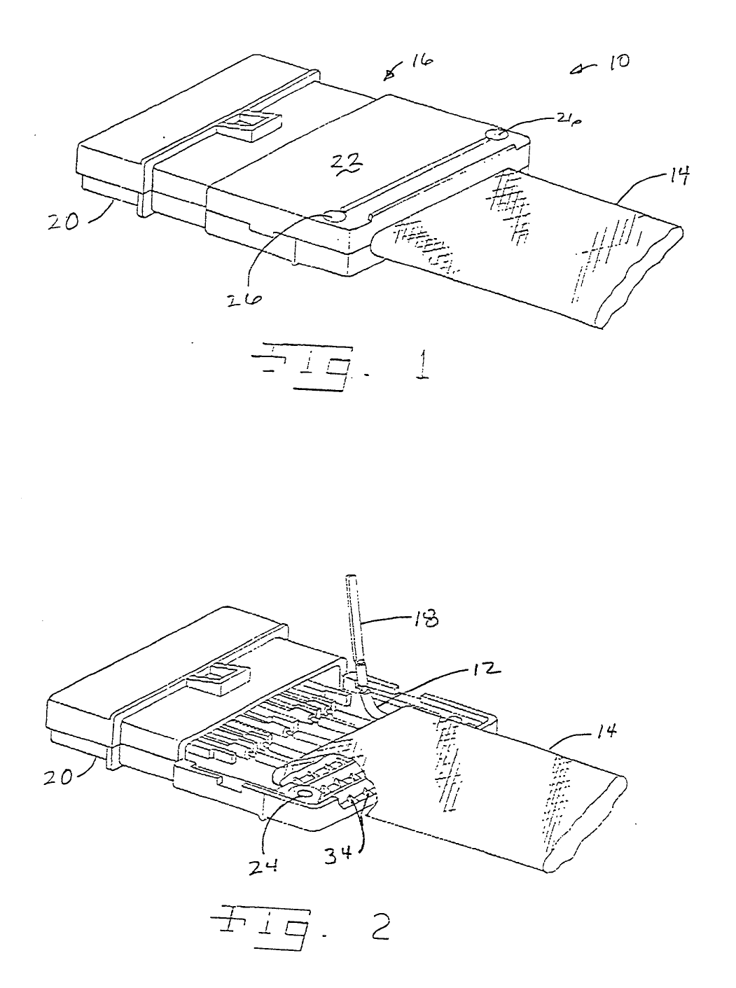

Referring now to the drawings, and more particularly to FIGS. 1 and 2, there is shown a fiberglass sleeved cable assembly, which generally includes electrical conductors 12, woven fiberglass sleeve 14 and connector housing 16.

Electrical conductors 12 are insulated electrical conductors, which are routed through fiberglass sleeve 14 and are terminated on at least one end with a connector terminal 18. On the end of electrical conductors 12 which are not shown it is anticipated that a similar termination is used, however any electrical termination may be utilized.

Connector terminal 18 is an electrical terminal which is crimped and/or soldered to a portion of electrical conductor 12 from which the insulation has been removed. Connector terminal 18 is shaped so as to be retained in connector housing 16 when connector housing 16 is assembled.

Connector housing 16 includes first housing portion 20 and second housing portion 22 with both housing portions having holes 24, through which fasteners 26 are installed to secure first housing portion 20 and second housing portion 22 together. Connector housing 16 secures connector terminals 18 and positions them to allow interconnection with a mating connector. Connector housing 16 engages woven fiberglass sleeve 14 in such a manner as to prevent woven fiberglass sleeve 14 from fraying and/or disengaging from connector housing 16.

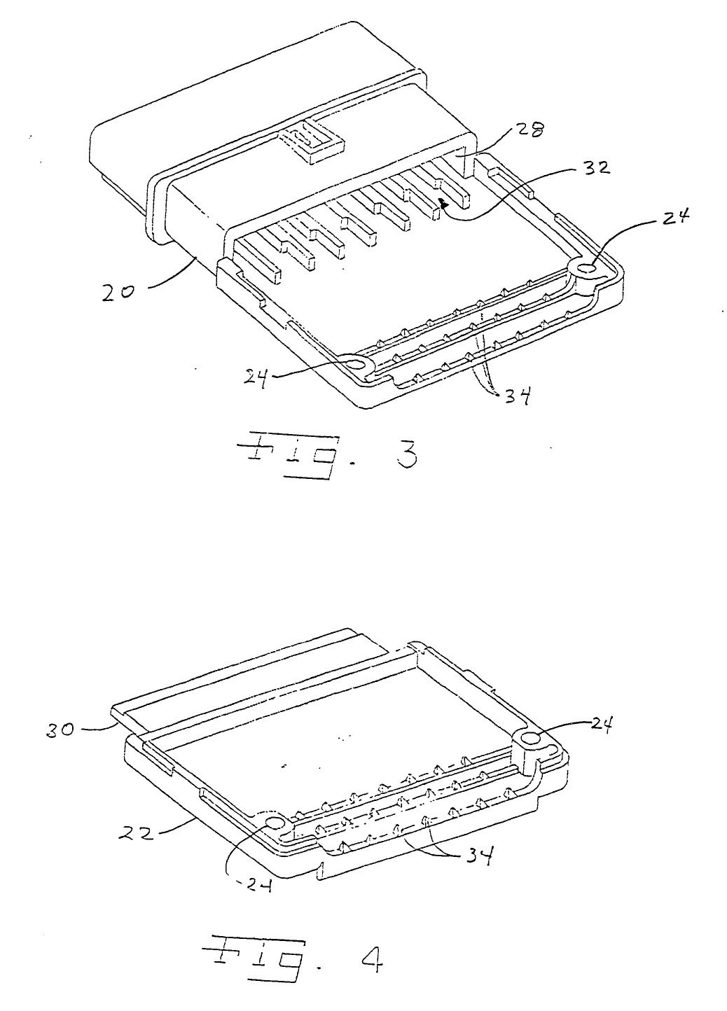

Now, additionally referring to FIGS. 3 and 4, connector housing 16 includes a first housing portion 20 and a second housing portion 22. First housing portion 20 and second housing portion 22 are complimentary with each other in that first housing portion has recess 28 which accommodates lip 30 of second housing portion 22. First housing portion 20 and second housing portion 22 are made from an electrically nonconductive material, such as thermal injected plastic. Holes 24 in first housing portion 20 and second housing portion 22 are positioned to align when lip 30 is slid into recess 28.

First housing portion 20 includes a plurality of terminal channels 32 and a plurality of pointed projections 34. Terminal channels 32 serve to position connector terminals 18 and to electrically isolate connector terminals 18 from each other. Second housing portion 22 likewise includes a plurality of pointed projections 34.

Pointed projections 34 are positioned, in at least one row, in an area of first housing portion 20 and second housing portion 22 in which woven fiberglass sleeve 14 is placed during the assembly of connector housing 16. Pointed projections 34 are integral to first housing portion 20 and second housing portion 22. Pointed projections 34 extend from first housing portion 20 and second housing portion 22 in such a manner as to engage woven fiberglass sleeve 14. When first housing portion 20 and second housing portion 22 are assembled, the spacing between pointed projections 34 of first housing portion 20 and pointed projections 34 of second housing portion 22 allow electrical conductors 12 to pass therebetween. Pointed projections 34 of first housing portion 20 and second housing portion 22 may impart some compressive force on electrical conductors 12 when connector housing 16 is assembled. When first housing portion 20 and second housing portion 22 are assembled, thereby forming connector housing 16, the rows of pointed projections 34 are substantially parallel with each other.

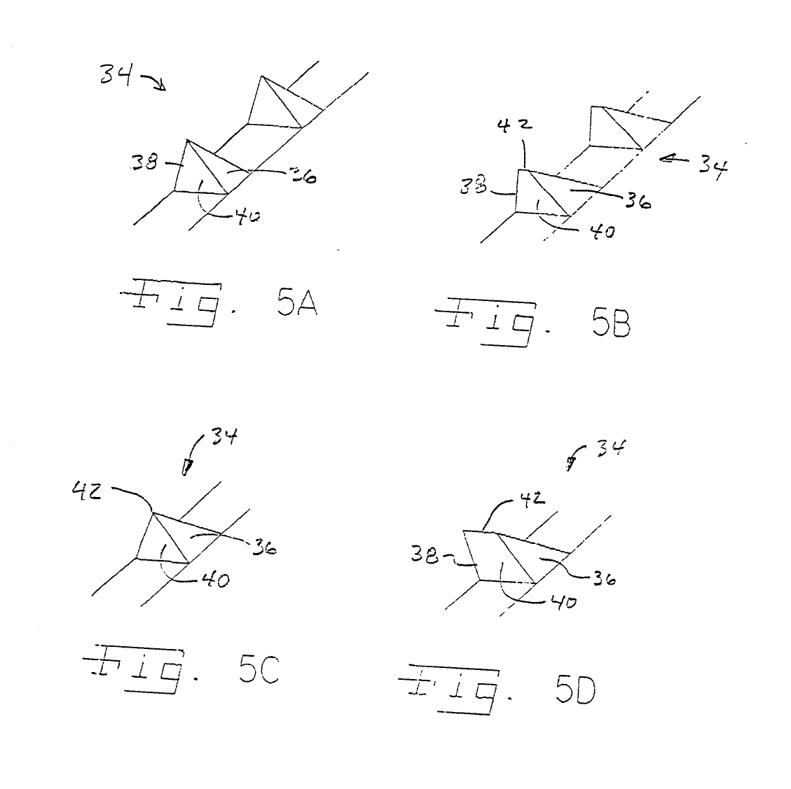

Now, additionally referring to FIGS. 5A through 5D, there are depicted details of pointed projections 34. Pointed projections 34 include a rear ramp side 36, a front side 38, two adjacent sides 40 and a top portion 42. Pointed projections 34 may be described as pyramid shaped, cone shaped, triangular shaped or the like, coming to a point or chisel point with the edge of the chisel running substantially parallel to the direction in which electrical conductors 12 are arranged in connector housing 16.

Rear ramp side 36 faces the end of first housing portion 20 and second housing portion 22 from which woven fiberglass sleeve 14 enters connector housing 16. Rear ramp side 36 ascends from first housing portion 20 and second housing portion 22 as an inclined plane ending at top portion 42. Alternatively, rear ramp side 36 may be shaped in a curved manner becoming generally tangential to adjacent sides 40.

Front side 38 is substantially perpendicular to the surface of first housing portion 20 and second housing portion 22 as depicted in FIGS. 5A and 5B. Alternatively, front side 38 may form an angle with first housing portion 20 and second housing portion 22 as depicted in FIGS. 5C and 5D.

Adjacent sides 40 are substantially planar in nature forming an obtuse angle with first housing portion 20 and second housing portion 22 as depicted in FIGS. 5A, 5B, 5C and 5D. Adjacent sides 40 meet at top portion 42 thereby forming a point or an edge. Alternatively, adjacent sides 40 may be of any shape including curved yet meet and thereby form a point or an edge.

Top portion 42 is substantially parallel with the base of projection 34 as depicted in FIGS. 5B and 5D. Top portion 42 may be an edge having a small flat or rounded surface. When top portion 42 is embodied as an edge the edge is directed parallel to a direction in which electrical conductors 12 are arranged in connector housing 16. Alternatively, top portion 42 may be formed as a point as depicted in FIGS. 5A and 5C.

Fiberglass sleeved cable assembly 10 may be manufactured from the aforementioned components. Electrical conductors 12 are connected to connector terminals 18 and inserted into fiberglass sleeve 14. An end of fiberglass sleeve 14 containing electrical conductors 12 is inserted into an opening of connector housing 16, directing connector terminals 18 into terminal channels 32. Connector housing 16 is oriented such that pointed projections 34 grip fiberglass sleeve 14, thereby constraining the movement of fiberglass sleeve 14 relative to connector housing 16.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fiberglass sleeved electrical cable assembly, comprising:
a plurality of electrical conductors;
a fiberglass sleeve carrying said plurality of electrical conductors therein; and
a connector, comprising a housing including a first end having an opening with an inner surface to accommodate said fiberglass sleeve and said plurality of electrical conductors, said inner surface having a plurality of pointed projections, each said pointed projection having a ramped side extending farther from said inner surface in a direction away from said opening.

2. The assembly of claim 1, further comprising at least one electrical terminal being constrained within said housing and electrically connected to at least one of said plurality of electrical conductors.

3. The assembly of claim 1, wherein each said adjacent side of said pointed projections form an obtuse angle with said inner surface.

4. The assembly of claim 1, wherein said pointed projections each have a front side opposite said ramped side and adjacent to said two adjacent sides, said front side being at least one of generally perpendicular to said inner surface and forming an acute angle with said inner surface.

5. The assembly of claim 1, wherein said plurality of pointed projections are formed in at least one row on said inner surface.

6. The assembly of claim 1, wherein said plurality of pointed projections are arranged in a plurality of rows on said inner surface.

7. The assembly of claim 1, wherein said housing includes at least two housing portions, each said housing portion configured to connect with at least one other said housing portion.

8. The assembly of claim 1, wherein said pointed projections include two adjacent sides being adjacent to said ramped side extending from said inner surface meeting to form one of a pyramid-shaped point and a chisel point oriented substantially parallel with a direction said electrical conductors are oriented within said connector.

9. An electrical connector for coupling with a plurality of electrical conductors enclosed in a fiberglass sleeve, said electrical connector, comprising:
a housing including a first end having an opening with an inner surface, said opening configured for receiving said plurality of electrical conductors therein; and
a plurality of pointed projections on said inner surface, each said pointed projection being configured with a ramped side extending farther from said inner surface in a direction away from said opening.

10. The connector of claim 9, wherein each said adjacent side of said pointed projections form an obtuse angle with said inner surface.

11. The connector of claim 9, wherein said pointed projections each have a front side opposite said ramped side and adjacent to said two adjacent sides, said front side being at least one of generally perpendicular to said inner surface and forming an acute angle with said inner surface.

12. The connector of claim 9, wherein said plurality of pointed projections are formed in at least one row on said inner surface.

13. The connector of claim 9, wherein said plurality of pointed projections are arranged in a plurality of rows on said inner surface.

14. The connector of claim 9, wherein said housing includes at least two housing portions, each said housing portion configured to connect with at least one other said housing portion.

15. The connector of claim 9, wherein said pointed projections include two adjacent sides being adjacent to said ramped side extending from said inner surface meeting to form one of a pyramid-shaped point and a chisel point oriented substantially parallel with a direction said electrical conductors are oriented within said connector.

16. A method of forming an electrical cable assembly, comprising the steps of:
providing a fiberglass sleeve to carry a plurality of electrical conductors therein;
providing a housing having a first end with an opening, an inner surface and a plurality of projections on said inner surface, each said projection being configured with a ramped side extending farther from said inner surface in a direction away from said opening;
positioning said fiberglass sleeve within said opening; and
gripping said fiberglass sleeve with said projections.

17. The method of claim 16, further comprising the steps of:
connecting an end of at least one of said plurality of electrical connectors with an electrical terminal; and
inserting said electrical terminal into a terminal channel within said housing.
